(19) United States
(12) Patent Application Publication
(10) Pub. No.: US 2025/0236227 A1
(43) Pub. Date: Jul. 24, 2025

(54) VEHICLE SEAT

(71) Applicant: TOYOTA BOSHOKU KABUSHIKI KAISHA, Aichi (JP)

(72) Inventors: Yoshiomi NISHIGAKI, Ichinomiya-shi (JP); Yasuhito TSUYOSHI, Miyoshi-shi (JP); Kazumi INOUE, Nisshin-shi (JP)

(73) Assignee: TOYOTA BOSHOKU KABUSHIKI KAISHA, Aichi (JP)

(21) Appl. No.: 19/020,222

(22) Filed: Jan. 14, 2025

(30) Foreign Application Priority Data
Jan. 22, 2024 (JP) 2024-007318

(51) Int. Cl. B60N 2/66; B60N 2/62

(52) U.S. Cl. CPC B60N 2/66; B60N 2/62

(57) ABSTRACT

A vehicle seat is provided that reduces differences in seating comfort due to different postures of occupants. The vehicle seat is mounted in a vehicle and includes a seat cushion and a seatback. The seat cushion includes a buttocks-support seat surface configured to support from below buttocks of an occupant and a thigh-support seat surface configured to support from below thighs of the occupant. The seatback includes a lumbar-region support surface configured to support a lumbar region of the occupant and a thoracic-region support surface configured to support a thoracic region of the occupant. The seat cushion and the seatback are arranged such that a hip angle formed by the buttocks-support seat surface and the lumbar-region support surface is 93° to 101°. The seatback is formed such that a neck angle formed by the lumbar-region support surface and the thoracic-region support surface is 17.4° to 24.2°.

### CROSS-REFERENCE TO RELATED APPLICATIONS

The present application claims the priority based on Japanese Patent Application No. 2024-007318 filed on Jan. 22, 2024 with the Japan Patent Office, entire disclosure of which is incorporated herein by reference.

### BACKGROUND

The present disclosure relates to a vehicle seat to be mounted in a vehicle.

Japanese Unexamined Patent Application Publication No. 2020-199919 discloses that pressure distributions on a vehicle seat measured when occupants of the vehicle seat feel comfortable vary due to differences in sitting postures of the occupants (for example, a standard posture, a hunched back posture, a swayback posture, and the like) sitting on the vehicle seat.

### SUMMARY

Unfortunately, there have been cases where a vehicle seat that is considered acceptable for sitting for an occupant in a first posture (for example, the standard posture) may be considered unacceptable for sitting for an occupant in a second posture (for example, the hunched back posture or the swayback posture) which is different from the first posture.

It is desirable in one aspect of the present disclosure to reduce differences in seating comfort due to different postures of occupants.

One aspect of the present disclosure provides a vehicle seat to be mounted in a vehicle. The vehicle seat includes a seat cushion and a seatback.

The seat cushion includes, in an order from a rear side thereof along a front-rear direction of the vehicle, a buttocks-support seat surface configured to support from below buttocks of an occupant sitting on the vehicle seat, and a thigh-support seat surface configured to support from below thighs of the occupant.

The seatback includes, in an order from a lower side thereof along the up-down direction of the vehicle, a lumbar-region support surface configured to support a lumbar region of the occupant, and a thoracic-region support surface configured to support a thoracic region of the occupant.

The seat cushion and the seatback are arranged such that a hip angle formed by the buttocks-support seat surface and the lumbar-region support surface is 93° to 101°.

The seatback is formed such that a neck angle formed by the lumbar-region support surface and the thoracic-region support surface is 17.4° to 24.2°.

The vehicle seat of the present disclosure configured as above makes more occupants feel that such a vehicle seat is acceptable for sitting irrespective of their postures. Thus, the vehicle seat of the present disclosure can reduce the differences in seating comfort due to different postures of the occupants.

In one aspect of the present disclosure, the hip angle may be 97°, and the neck angle may be 20.8°.

The vehicle seat of the present disclosure configured as above can further reduce the differences in seating comfort due to different postures of the occupants.

### BRIEF DESCRIPTION OF THE DRAWINGS

Example embodiments of the present disclosure will be described hereinafter with reference to the accompanying drawings, in which:

FIG. 1 is a perspective view showing a configuration of a vehicle seat;

FIG. 2 is a diagram illustrating a hip angle and a neck angle of the vehicle seat;

FIG. 3 is a bubble chart and graphs showing results of a sensory evaluation in which subjects each selected the most comfortable vehicle seat from several vehicle seats provided; and

FIG. 4 is a bubble chart showing results of a sensory evaluation in which the subjects responded whether the respective vehicle seats are acceptable for sitting.

### DETAILED DESCRIPTION OF EXEMPLARY EMBODIMENTS

### 1. First Embodiment

### 1-1. Configuration of Vehicle Seat

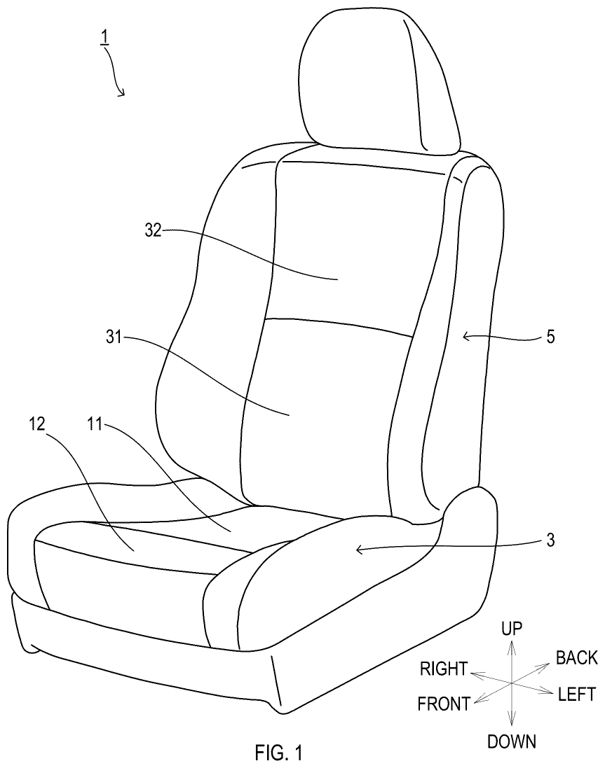

The following embodiment provides a vehicle seat 1 to be mounted in a vehicle. As shown in FIG. 1, the vehicle seat 1 includes a seat cushion 3 and a seatback 5. The seat cushion 3 is a portion for supporting an occupant's buttocks. The seatback 5 is a portion for supporting the occupant's back.

The vehicle seat 1 of the present embodiment is used as a seat for a passenger car. The directions in the following description and each drawing refer to the directions of the vehicle seat 1 mounted in the vehicle. In the present embodiment, the seat-width direction corresponds to the left-right direction of the vehicle, and the seat-front corresponds to the front of the vehicle.

The seat cushion 3 includes, in the order from the rear side thereof along the front-rear direction of the vehicle, a buttocks-support seat surface 11 that supports mainly the occupant's buttocks from below, and a thigh-support seat surface 12 that supports mainly the occupant's thighs from below.

The seatback 5 includes, in the order from the lower side thereof along the up-down direction of the vehicle, a lumbar-region support surface 31 that supports mainly the occupant's lumbar region, and a thoracic-region support surface 32 that supports mainly the occupant's thoracic region.

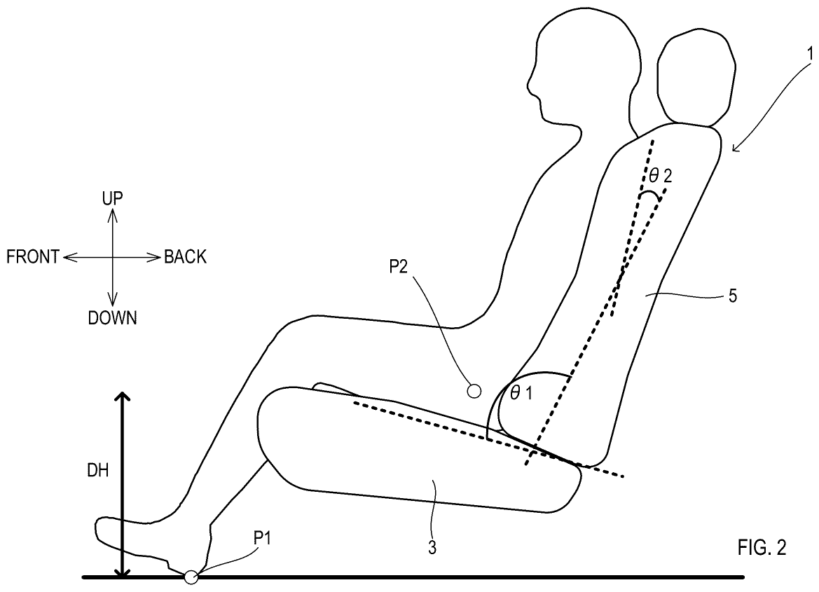

As shown in FIG. 2, the vehicle seat 1 has a hip angle θ1 formed by the buttocks-support seat surface 11 and the lumbar-region support surface 31. The vehicle seat 1 has a neck angle θ2 formed by the lumbar-region support surface 31 and the thoracic-region support surface 32.

In the vehicle seat 1 of the present embodiment, the height difference between a heel point P1 and a hip point P2 (hereinafter, a heel-to-hip height difference DH) is 200 mm to 360 mm. The heel point P1 is a position where the occupant's heel touches the floor of the vehicle. The hip point P2 is the outermost part of the occupant's femur.

### 1-2. Sitting Posture Sensory Evaluation

The applicant of the present application conducted a sensory evaluation with 350 employees thereof as subjects. In the sensory evaluation, each subject sat on a first, a second, a third, a fourth, a fifth, a sixth, a seventh, an eighth, and a ninth vehicle seat, which provided sitting postures different from each other, and selected the most comfortable vehicle seat. The 350 employees included employees from Japan, United States, Europe, and Thailand.

For the first vehicle seat, the hip angle θ1 is set at 89° and the neck angle θ2 is set at 27.6°. The first vehicle seat corresponds to a swayback sitting posture.

For the second vehicle seat, the hip angle θ1 is set at 105° and the neck angle θ2 is set at 14.0°. The second vehicle seat corresponds to a hunched back sitting posture.

For the third vehicle seat, the hip angle θ1 is set at 89° and the neck angle θ2 is set at 14.0°. The third vehicle seat corresponds to a forward-leaning sitting posture.

For the fourth vehicle seat, the hip angle θ1 is set at 105° and the neck angle θ2 is set at 27.6°. The fourth vehicle seat corresponds to a backward-leaning sitting posture.

For the fifth vehicle seat, the hip angle θ1 is set at 97° and the neck angle θ2 is set at 20.8°. The fifth vehicle seat corresponds to a middle sitting posture which is in the middle of all the swayback, hunched back, forward-leaning, and backward-leaning sitting postures.

For the sixth vehicle seat, the hip angle θ1 is set at 93° and the neck angle θ2 is set at 24.2°.

For the seventh vehicle seat, the hip angle θ1 is set at 101° and the neck angle θ2 is set at 17.4°.

For the eighth vehicle seat, the hip angle θ1 is set at 93° and the neck angle θ2 is set at 17.4°.

For the ninth vehicle seat, the hip angle θ1 is set at 101° and the neck angle θ2 is set at 24.2°.

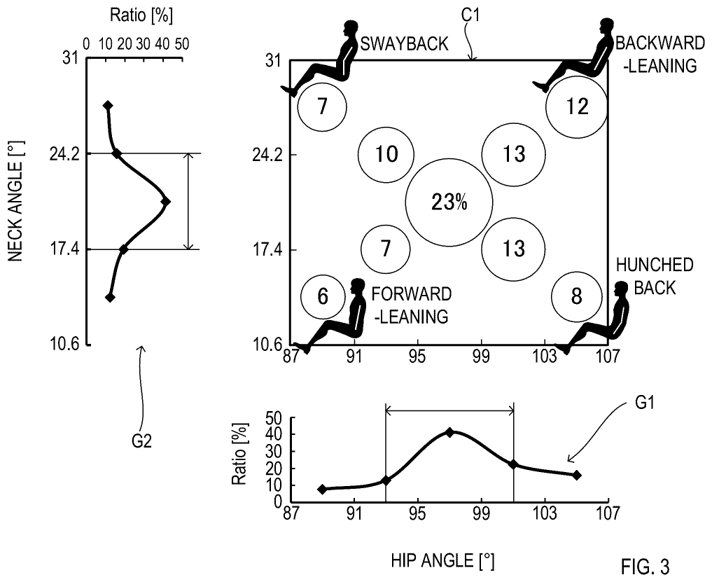

As shown in a bubble chart C1 of FIG. 3, subjects who responded that the first vehicle seat was the most comfortable for sitting accounted for 7% of all the subjects.

Subjects who responded that the second vehicle seat was the most comfortable for sitting accounted for 8% of all the subjects.

Subjects who responded that the third vehicle seat was the most comfortable for sitting accounted for 6% of all the subjects.

Subjects who responded that the fourth vehicle seat was the most comfortable for sitting accounted for 12% of all the subjects.

Subjects who responded that the fifth vehicle seat was the most comfortable for sitting accounted for 23% of all the subjects.

Subjects who responded that the sixth vehicle seat was the most comfortable for sitting accounted for 10% of all the subjects.

Subjects who responded that the seventh vehicle seat was the most comfortable for sitting accounted for 13% of all the subjects.

Subjects who responded that the eighth vehicle seat was the most comfortable for sitting accounted for 7% of all the subjects.

Subjects who responded that the ninth vehicle seat was the most comfortable vehicle for sitting accounted for 13% of all the subjects.

A graph G1 in FIG. 3 shows distribution of the hip angle θ1 that is converted from the distribution in the bubble chart C1.

With regard to the first vehicle seat and the third vehicle seat each having the hip angle θ1 of 89°, the subjects who responded “most comfortable for sitting” account for 7% and 6%, respectively. Thus, the percentage of the subjects who preferred (in other words, felt most comfortable) the vehicle seats with the hip angle θ1 of 89° is on average (7+6)/2=6.5%.

With regard to the sixth vehicle seat and the eighth vehicle seat each having the hip angle θ1 of 93°, the subjects who responded “most comfortable for sitting” account for 10% and 7%, respectively. Thus, the percentage of the subjects who preferred the vehicle seats with the hip angle θ1 of 93° is on average (10+7)/2=8.5%.

With regard to the fifth vehicle seat having the hip angle θ1 of 97°, the subjects who responded “most comfortable for sitting” account for 23%. Thus, the percentage of the subjects who preferred the vehicle seat with the hip angle θ1 of 97° is on average 23%.

With regards to the seventh vehicle seat and the ninth vehicle seat each having the hip angle θ1 of 101°, the subjects who responded “most comfortable for sitting” account for 13% and 13%, respectively. Thus, the percentage of the subjects who preferred the vehicle seats with the hip angle θ1 of 101° is on average (13+13)/2=13%.

With regard to the second vehicle seat and the fourth vehicle seat each having the hip angle θ1 of 105°, the subjects who responded “most comfortable for sitting” account for 8% and 12%, respectively. Thus, the percentage of the subjects who preferred the vehicle seats with the hip angle θ1 of 105° is on average (8+12)/2=10%.

The sum of the five averages mentioned above is (6.5+8.5+23+13+10)=61%. The graph G1 is obtained by multiplying each of the five averages by (100/61) to calculate respective percentages of the subjects who preferred the vehicle seats with the hip angles θ1 of 89°, 93°, 97°, 101°, and 105°.

As shown in the graph G1, when the hip angle θ1 changes from 89° to 93° the rate of increase is small in the percentage of the subjects who responded “most comfortable for sitting”.

When the hip angle θ1 changes from 93° to 97°, the rate of increase is large in the percentage of the subjects who responded “most comfortable”.

When the hip angle θ1 changes from 105° to 101°, the rate of increase is small in the percentage of the subjects who responded “most comfortable”.

When the hip angle θ1 changes from 101° to 97°, the rate of increase is large in the percentage of the subjects who responded “most comfortable”.

Thus, it is considered that the effect of reducing differences in seating comfort due to different postures of occupants is substantial when the hip angle θ1 is 93° to 101°.

A graph G2 in FIG. 3 shows distribution of the neck angle θ2 that is converted from the distribution in the bubble chart C1.

With regard to the second vehicle seat and the third vehicle seat each having the neck angle θ2 of 14.0°, the subjects who responded “most comfortable for sitting” account for 8% and 6%, respectively. Thus, the percentage of the subjects who preferred the vehicle seats with the neck angle θ2 of 14.0° is on average (8+6)/2=7%.

With regard to the seventh vehicle seat and the eighth vehicle seat each having the neck angle θ2 of 17.4°, the subjects who responded “most comfortable for sitting” account for 13% and 7%, respectively. Thus, the percentage of the subjects who preferred the vehicle seats with the neck angle θ2 of 17.4° is on average (13+7)/2=10%.

With regard to the fifth vehicle seat having the neck angle θ2 of 20.8°, the subjects who responded “most comfortable for sitting” account for 23%. Thus, the percentage of the subjects who preferred the vehicle seat with the neck angle θ2 of 20.8° is on average 23%.

With regard to the sixth vehicle seat and the ninth vehicle seat each having the neck angle θ2 of 24.2°, the subjects who responded “most comfortable for sitting” account for 10% and 13%, respectively. Thus, the percentage of the subjects who preferred the vehicle seats with the neck angle 02 of 24.2° is on average (10+13)/2=11.5%.

With regard to the first vehicle seat and the fourth vehicle seat each having the neck angle θ2 of 27.6°, the subjects who responded “most comfortable for sitting” account for 7% and 12%, respectively. Thus, the percentage of the subjects who preferred the vehicle seats with the neck angle θ2 of 24.2° is on average (7+12)/2=9.5%.

The sum of the five averages mentioned above is (7+10+23+11.5+9.5)=61%. The graph G2 is obtained by multiplying each of the five averages by (100/61) to calculate respective percentages of the subjects who preferred the vehicle seats with the neck angles θ2 of 14.0°, 17.4°, 20.8°, 24.2°, and 27.6°.

As shown in the graph G2, when the neck angle θ2 changes from 14.0° to 17.4°, the rate of increase is small in the percentage of the subjects who responded “most comfortable for sitting”.

When the neck angle θ2 changes from 17.4° to 20.8°, the rate of increase is large in the percentage of the subjects who responded “most comfortable for sitting”.

When the neck angle θ2 changes from 27.6° to 24.2°, the rate of increase is small in the percentage of the subjects who responded “most comfortable for sitting”.

When the neck angle θ2 changes from 24.2° to 20.8°, the rate of increase is large in the percentage of the subjects who responded “most comfortable for sitting”.

Thus, it is considered that the effect of reducing the differences in seating comfort due to different postures of the occupants is substantial when the neck angle θ2 is 17.4° to 24.2°.

The applicant of the present application conducted a sensory evaluation with 350 employees thereof as subjects. In the sensory evaluation, when each subject sat on each of the above-described first, second, third, fourth, and fifth vehicle seats, which provided sitting postures different from each other, the subject responded whether the vehicle seat was acceptable for sitting.

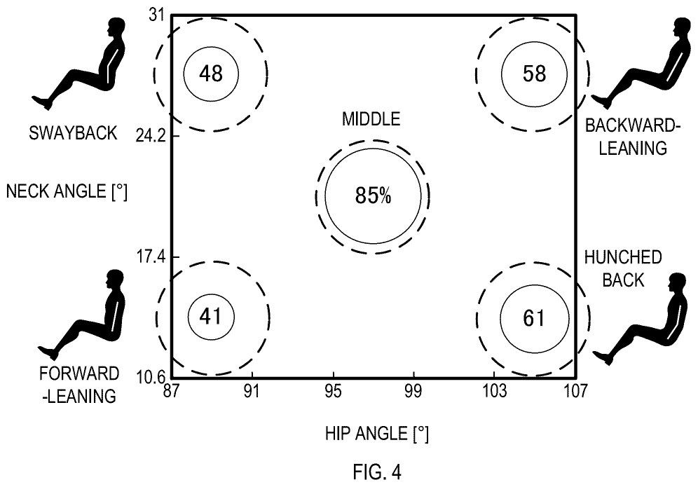

As shown in FIG. 4, with regard to the first vehicle seat, 48% of all the subjects responded “acceptable”.

With regard to the second vehicle seat, 61% of all the subjects responded “acceptable”.

With regard to the third vehicle seat, 41% of all the subjects responded “acceptable”.

With regard to the fourth vehicle seat, 58% of all the subjects responded “acceptable”.

With regard to the fifth vehicle seat, 85% of all the subjects responded “acceptable”.

In FIG. 4, the areas of the circles formed by dashed lines each indicate 100%. The areas of the circles formed by solid lines in FIG. 4 each indicate the percentage out of 100%.

According to the bubble chart in FIG. 4, it is considered that the effect of reducing the differences in seating comfort due to different postures of the occupants is substantial when the hip angle θ1 is 97° and the neck angle θ2 is 20.8°.

### 1-3. Effects

According to the embodiment described above in detail, the following effects are achieved.

(1a) The vehicle seat 1 that is formed having the hip angle θ1 of 93° to 101° and the neck angle θ2 of 17.4° to 24.2° can reduce the differences in seating comfort due to different postures of the occupants.

(1b) The vehicle seat 1 that is formed having the hip angle θ1 of 97° and the neck angle θ2 of 20.8° can further reduce the differences in seating comfort due to different postures of the occupants.

### 2. Other Embodiments

One embodiment of the present disclosure has been described hereinabove. However, the present disclosure is not limited to the aforementioned embodiment and may be embodied in various forms.

(2a) Two or more functions achieved by one element of the above-described embodiments may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiments may be omitted. At least a part of the configurations in one of the above-described embodiments may be added to or replaced with the configuration in another one of the above-described embodiments.

What is claimed is:

1. A vehicle seat to be mounted in a vehicle, the vehicle seat comprising:
a seat cushion; and
a seatback,
the seat cushion including, in an order from a rear side thereof along a front-rear direction of the vehicle:
a buttocks-support seat surface configured to support from below buttocks of an occupant sitting on the vehicle seat; and
a thigh-support seat surface configured to support from below thighs of the occupant,
the seatback including, in an order from a lower side thereof along an up-down direction of the vehicle:
a lumbar-region support surface configured to support a lumbar region of the occupant; and
a thoracic-region support surface configured to support a thoracic region of the occupant,
the seat cushion and the seatback being arranged such that a hip angle formed by the buttocks-support seat surface and the lumbar-region support surface is 93° to 101°, and
the seatback being formed such that a neck angle formed by the lumbar-region support surface and the thoracic-region support surface is 17.4° to 24.2°.

2. The vehicle seat according to claim 1, wherein
the hip angle is 97°, and
the neck angle is 20.8°.
